(19) United States
(12) Patent Application Publication
(10) Pub. No.: US 2026/0011164 A1
(43) Pub. Date: Jan. 8, 2026

(54) INFORMATION PROCESSING APPARATUS, SELECTION METHOD, AND NON-TRANSITORY COMPUTER-READABLE RECORDING MEDIUM

(71) Applicant: NEC Corporation, Tokyo (JP)

(72) Inventors: Masaya FUJIWAKA, Tokyo (JP); Junichi Funada, Tokyo (JP); Jianquan Liu, Tokyo (JP); Ryo Furukawa, Tokyo (JP); Kazuya Kakizaki, Tokyo (JP); Yuto Matsunaga, Tokyo (JP); Toshinori Araki, Tokyo (JP)

(73) Assignee: NEC Corporation, Tokyo (JP)

(21) Appl. No.: 19/245,525

(22) Filed: Jun. 23, 2025

(30) Foreign Application Priority Data
Jul. 4, 2024 (JP) 2024-108425

(51) Int. Cl. G06V 20/70

(52) U.S. Cl. CPC G06V 20/70; G06V 2201/07

(57) ABSTRACT

An information processing apparatus acquires a frame image that is a constituent of a moving image that is an analysis target using a generative model subjected to machine learning in such a way that the generative model is able to generate an explanatory sentence of an image, and analyzes the acquired frame image. The information processing apparatus selects a frame image as a target of which an explanatory sentence is to be generated by the generative model based on an analysis result for the frame image. The information processing apparatus causes the generative model to generate an explanatory sentence of the frame image by using the frame image and an analysis result for the frame image.

### INCORPORATION BY REFERENCE

This application is based upon and claims the benefit of priority from Japanese patent application No. 2024-108425, filed on Jul. 4, 2024, the disclosure of which is incorporated herein in its entirety by reference.

### TECHNICAL FIELD

The present disclosure relates to an information processing apparatus, a selection method, and a non-transitory computer-readable recording medium.

### BACKGROUND ART

A language model capable of interpreting content of an image is known. For example, Patent Literature 1 discloses that content of a drawing included in patent information can be interpreted by using a large language model capable of interpreting content of an image.
[Patent Literature 1] Japanese Patent No. 7421740

### SUMMARY

A technique for causing a generative model such as a language model to generate an explanatory sentence of an image can also be used for analyzing a moving image. In this case, a frame image may be extracted from the moving image, each frame image may be input to the generative model, and the explanatory sentence may be generated.

Here, under the present circumstances, it cannot be said that the time required to generate an explanatory sentence from a generative model is short. Thus, it is not realistic to generate explanatory sentences for all frame images, and some of the frame images have to be sampled and input to the generative model. However, in a case where some of the frame images are sampled, there is a possibility that a frame image including important information will be omitted from the sampling. For example, in a case of analyzing a moving image captured by a monitoring camera, a frame image showing a moment of an incident or an accident may be omitted from sampling. In this case, since an explanatory sentence of the frame image showing the moment of the incident or the accident is not generated, there is a possibility that detection omission of the incident or the accident occurs.

The present disclosure has been made in view of such a problem, and an example object thereof is to provide a technique for reducing a possibility that a frame image including important information among frame images extracted from a moving image will be omitted from an explanatory sentence generation target of a generative model.

An information processing apparatus according to a first example aspect includes:
at least one memory storing instructions; and
at least one processor executing the instructions to:
acquire a frame image that is a constituent of a moving image that is an analysis target using a generative model subjected to machine learning in such a way that the generative model is able to generate an explanatory sentence of an image,
analyze the acquired frame image, and
select a frame image as a target of which an explanatory sentence is to be generated by the generative model based on an analysis result.

A selection method according to a second example aspect includes:
an image acquisition process of acquiring, by a computer, a frame image that is a constituent of a moving image that is an analysis target using a generative model subjected to machine learning in such a way that the generative model is able to generate an explanatory sentence of an image; and
a selection process of selecting, by the computer, a frame image as a target of which an explanatory sentence is to be generated by the generative model based on an analysis result obtained by analyzing the acquired frame image.

A selection program stored in a non-transitory computer-readable recording medium according to a third example aspect causes a computer to execute:
an image acquisition process of acquiring a frame image that is a constituent of a moving image that is an analysis target using a generative model subjected to machine learning in such a way that the generative model is able to generate an explanatory sentence of an image; and
a selection process of selecting a frame image as a target of which an explanatory sentence is to be generated by the generative model based on an analysis result obtained by analyzing the acquired frame image.

According to an exemplary aspect of the present disclosure, it is possible to achieve an exemplary effect of providing a technique for reducing a possibility that a frame image including important information among frame images extracted from a moving image will be omitted from an explanatory sentence generation target of a generative model.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of a selection method according to the present disclosure;

FIG. 3 is a block diagram illustrating a configuration of another information processing apparatus according to the present disclosure;

FIG. 4 is a diagram illustrating an example of selection of a frame image extracted from a moving image;

FIG. 5 is a flowchart illustrating a flow of a process executed by the information processing apparatus illustrated in FIG. 3;

FIG. 6 is a flowchart illustrating details of a process in S12 in FIG. 5;

FIG. 7 is a block diagram illustrating a configuration of a monitoring support apparatus according to the present disclosure;

FIG. 8 is a flowchart illustrating a flow of a process executed by the monitoring support apparatus illustrated in FIG. 7; and

FIG. 9 is a block diagram illustrating a configuration of a computer that functions as an information processing apparatus or a monitoring support apparatus according to the present disclosure.

### EXAMPLE EMBODIMENTS

Hereinafter, exemplary embodiments of the present invention will be described. However, the present disclosure is not limited to exemplary embodiments described below, and various alterations can be made within the scope described in the claims. For example, exemplary embodiments obtained by appropriately combining techniques (some or all of things or methods) adopted in the following exemplary embodiments can also be included in the scope of the present invention. Embodiments obtained by appropriately omitting some of the techniques adopted in the following exemplary embodiments can also be included in the scope of the present invention. Effects mentioned in the following exemplary embodiments are examples of effects expected in the exemplary embodiments, and do not define the extension of the present invention. That is, exemplary embodiments that do not achieve the effects mentioned in the following exemplary embodiments can also be included in the scope of the present invention.

### First Exemplary Embodiment

A first exemplary embodiment will be described in detail with reference to the drawings. The present exemplary embodiment is a basic form of each exemplary embodiment described below. An application scope of each technique adopted in the present exemplary embodiment is not limited to the present exemplary embodiment. That is, each technique adopted in the present exemplary embodiment can also be adopted in the other exemplary embodiments included in the present disclosure within the scope in which no particular technical problem occurs. Each technique illustrated in the drawings referred to for describing the present exemplary embodiment can also be employed in the other exemplary embodiments included in the present disclosure within a range in which no particular technical problem occurs.

### (Configuration of Information Processing Apparatus)

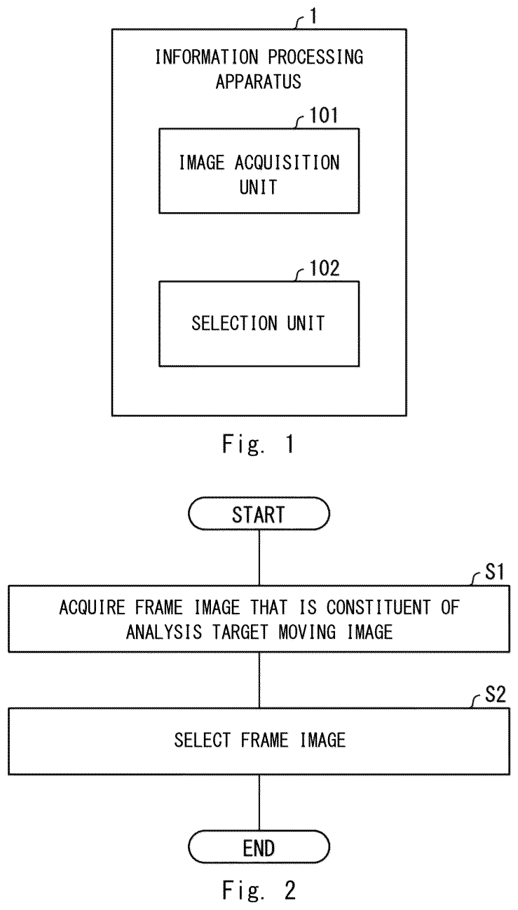

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes an image acquisition unit 101 and a selection unit 102.

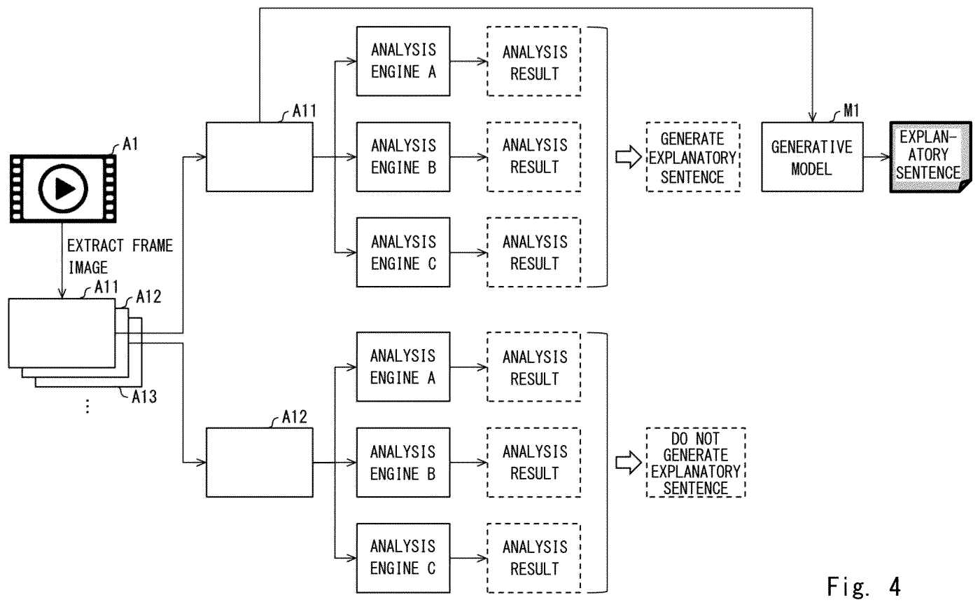

The image acquisition unit 101 acquires a frame image that is a constituent of a moving image that is an analysis target using a generative model subjected to machine learning in such a way that the generative model can generate an explanatory sentence of an image. For example, as will be described later with reference to FIG. 4, the image acquisition unit 101 may extract, from a moving image included in content that is a target for authenticity determination, a frame image that is a constituent of the moving image.

The “generative model” may be any model as long as the model is generated through machine learning in such a way that an explanatory sentence of an image can be generated. For example, a vision language model (VLM), contrastive language-image pretraining (CLIP), bootstrapping language image pre-training for unified vision-language understanding and generation (BLIP), or vision-and-language BERT (ViLBERT) may be used as the generative model. Here, the “explanatory sentence” is text indicating the details of a part or the whole of the image. The “explanatory sentence” only needs to indicate the details of the image, and can thus be rephrased as, for example, a summary or a summary sentence of the image. Any moving image can be applied as an analysis target moving image.

The selection unit 102 selects a frame image as a target of which an explanatory sentence is to be generated by the generative model based on an analysis result obtained by analyzing the frame image acquired by the image acquisition unit 101. A frame image may be selected every time the frame image is acquired. In this case, the selection unit 102 determines, for each frame image, whether to cause the generative model to generate an explanatory sentence of the frame image. After a plurality of frame images is acquired, the selection unit 102 may select a frame image as a target of which an explanatory sentence is to be generated by the generative model from among the plurality of frame images.

The analysis of the frame image may be performed by the information processing apparatus 1 or may be performed by another apparatus. An analysis method is not particularly limited. However, it is necessary to apply an analysis method capable of obtaining an analysis result in a shorter time than a process of causing a generative model to generate an explanatory sentence of a frame image. It is necessary to apply an analysis method in which the analysis result serves as a material for determining whether to cause the generative model to generate an explanatory sentence. For example, as described below with reference to FIG. 4, the selection unit 102 may determine whether to generate an explanatory sentence based on an analysis result from an analysis engine that performs object detection or the like.

### (Effects of Information Processing Apparatus 1)

As described above, the information processing apparatus 1 employs a configuration including the image acquisition unit 101 that acquires a frame image that is a constituent of a moving image that is an analysis target using a generative model subjected to machine learning in such a way that the generative model can generate an explanatory sentence of an image, and the selection unit 102 that selects a frame image as a target of which an explanatory sentence is to be generated by the generative model based on an analysis result obtained by analyzing the acquired frame image. Therefore, according to the information processing apparatus 1, it is possible to reduce the possibility that a frame image including important information among frame images extracted from a moving image will be omitted from an explanatory sentence generation target of the generative model. According to the information processing apparatus 1, it is also possible to reduce the possibility that a user makes an erroneous decision due to omission of a frame image including important information from an explanatory sentence generation target.

### (Selection Program)

The functions of the above-described information processing apparatus 1 can also be achieved by a program. A selection program according to the present exemplary embodiment causes a computer to function as: image acquisition means for acquiring a frame image that is a constituent of a moving image that is an analysis target using a generative model subjected to machine learning in such a way that the generative model can generate an explanatory sentence of an image; and selection means for selecting a frame image as a target of which an explanatory sentence is to be generated by the generative model based on an analysis result obtained by analyzing the acquired frame image. According to this selection program, it is possible to achieve an effect of reducing a possibility that a frame image including important information among frame images extracted from a moving image will be omitted from an explanatory sentence generation target in the generative model.

### (Selection Method)

A flow of a selection method according to the present exemplary embodiment will be described with reference to FIG. 2. FIG. 2 is a flowchart illustrating a flow of a selection method. An executing entity of each step in this selection method may be a processor included in the information processing apparatus 1, may be a processor included in another apparatus, or may be a processor provided in an apparatus in which executing entities of each step are different.

In S1 (image acquisition process), at least one processor acquires a frame image that is a constituent of a moving image that is an analysis target using a generative model subjected to machine learning in such a way that the generative model can generate an explanatory sentence of an image.

In S2 (selection process), at least one processor selects a frame image as a target of which an explanatory sentence is to be generated by the generative model based on an analysis result obtained by analyzing the frame image acquired in S1. For example, in a case where one frame image is acquired in S1, in S2, the processor determines whether to cause the generative model to generate an explanatory sentence of the frame image based on an analysis result for the acquired frame image. For example, in a case where a plurality of frame images are acquired in S1, in S2, the processor selects some of the frame images as targets of which explanatory sentences are to be generated by the generative model based on analysis results for the plurality of acquired frame images.

### (Effect of Selection Method)

As described above, the selection method according to the present exemplary embodiment employs a method including an image acquisition process in which at least one processor acquires a frame image that is a constituent of a moving image that is an analysis target using a generative model subjected to machine learning in such a way that the generative model can generate an explanatory sentence of an image; and a selection process in which the processor selects a frame image as a target of which an explanatory sentence is to be generated by the generative model based on an analysis result obtained by analyzing the acquired frame image. Therefore, according to the selection method of the present example embodiment, it is possible to reduce the possibility that a frame image including important information among frame images extracted from a moving image will be omitted from an explanatory sentence generation target in the generative model.

### Second Exemplary Embodiment

A second exemplary embodiment will be described in detail with reference to the drawings. Constituents having the same functions as the constituents described in the above-described exemplary embodiment are denoted by the same reference signs, and the description thereof will be appropriately omitted. An application scope of each technique adopted in the present exemplary embodiment is not limited to the present exemplary embodiment. That is, each technique adopted in the present exemplary embodiment can also be adopted in the other exemplary embodiments included in the present disclosure within the scope in which no particular technical problem occurs. Each technique illustrated in each of the drawings referred to for describing the present exemplary embodiment can be employed in the other exemplary embodiments included in the present disclosure within the scope in which no particular technical problem occurs.

### (Configuration of Information Processing Apparatus 1A)

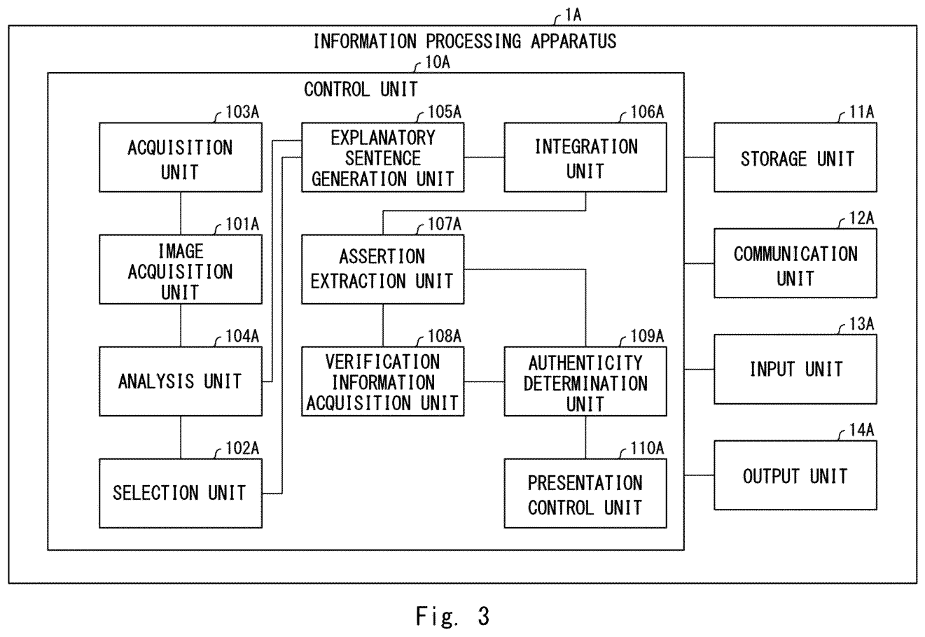

A configuration of an information processing apparatus 1A according to the present exemplary embodiment will be described with reference to FIG. 3. FIG. 3 is a block diagram illustrating the configuration of the information processing apparatus 1A. The information processing apparatus 1A includes a control unit 10A that integrally controls each unit of the information processing apparatus 1A and a storage unit 11A that stores various data used by the information processing apparatus 1A. The information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. The control unit 10A includes an acquisition unit 103A, an image acquisition unit 101A, an analysis unit 104A, a selection unit 102A, an explanatory sentence generation unit 105A, an integration unit 106A, an assertion extraction unit 107A, a verification information acquisition unit 108A, an authenticity determination unit 109A, and a presentation control unit 110A.

The acquisition unit 103A acquires a content that is a target for determining the authenticity of the assertion details. Here, the “assertion details” are related to a concept, information, and the like that are assumed to be recognized by a recipient of the content by receiving the content. The content acquired by the acquisition unit 103A may include at least a moving image. For example, the acquisition unit 103A may acquire a news article on the Internet including a moving image as a content for which the authenticity of the assertion details is to be determined.

Similarly to the image acquisition unit 101 described in the first exemplary embodiment, the image acquisition unit 101A acquires a frame image that is a constituent of a moving image that is an analysis target using a generative model subjected to machine learning in such a way that the generative model can generate an explanatory sentence of an image. As described above, the acquisition unit 103A acquires the content including the moving image as the content for determining the authenticity of the assertion details. Thus, the moving image is an analysis target. Therefore, the image acquisition unit 101A acquires (which may also be referred to as “extracts”) a frame image that is a constituent of the moving image from the moving image that is an analysis target.

Specifically, the image acquisition unit 101A may sequentially acquire time-series frame images from the moving image. As will be described later, such a configuration is effective for analysis in which a real-time property is required, such as monitoring using a moving image. The image acquisition unit 101A may acquire a plurality of frame images from the moving image. In this case, the image acquisition unit 101A may acquire a predetermined number of consecutive frame images in time series from the moving image.

The analysis unit 104A analyzes the frame image acquired by the image acquisition unit 101A. An analysis method applied by the analysis unit 104A is any method. For example, the analysis unit 104A may execute a process of detecting a predetermined target from a frame image. Examples of an analysis engine that executes a process of detecting a predetermined target from a frame image include a person detection engine and a person tracking engine. The analysis unit 104A may perform analysis by using such an analysis engine. For example, the analysis unit 104A may analyze the frame image by using at least one of an emotion analysis engine, a behavior recognition engine, a location detection engine, or a driving video analysis engine. In a case where the moving image that is an analysis target includes speech, the analysis unit 104A may analyze the speech by using a speech recognition engine. In a case where a plurality of analysis engines can be used, the analysis unit 104A may select an analysis engine to be used according to a frame image that is an analysis target. In addition to this, for example, an analysis engine or the like that detects occurrence of abnormality may be used. In a case where a plurality of analysis methods are applied, the analysis unit 104A may be provided for each analysis method.

The person detection engine has a function of detecting a person shown in an input image. For example, by combining the person detection engine and a face analysis engine, it is also possible to perform analysis for specifying a detected person. The emotion analysis engine has a function of estimating an expression or an emotion of a person shown in an input image. The behavior recognition engine has a function of recognizing a behavior of a person shown in an input image. For example, the behavior of the person can be recognized by using a pose analysis engine that analyzes a pose of the person and a change in the analyzed pose. The person tracking engine has a function of tracking a person shown in an input image. The location detection engine has a function of detecting a location shown in an input image. The driving video analysis engine has a function of detecting a pedestrian, a signal, a vehicle, and the like shown in a driving video in a case where the input image is the driving video obtained by imaging an external situation during traveling of a vehicle. The speech recognition engine has a function of converting speech accompanying an input image into text.

Similarly to the selection unit 102 described in the first exemplary embodiment, the selection unit 102A selects a frame image as a target of which an explanatory sentence is to be generated by the generative model based on an analysis result obtained by analyzing the frame image acquired by the image acquisition unit 101A. Specifically, the selection unit 102A selects a frame image of which the generative model is caused to generate an explanatory sentence from among the frame images acquired by the image acquisition unit 101A based on the analysis result from the analysis unit 104A. As described above, a frame image to be selected by the selection unit 102A is a constituent of a moving image included in a content that is an authenticity determination target.

The selection unit 102A is operable as in the following (1) and (2) according to the method of acquiring time-series frame images from a moving image in the image acquisition unit 101A.

(1) A Case where the Image Acquisition Unit 101A Sequentially Acquires Time-Series Frame Images from a Moving Image

Every time a frame image is acquired by the image acquisition unit 101A, the selection unit 102A performs a process of determining whether to cause the generative model to generate an explanatory sentence of the frame image based on a result of analyzing the acquired frame image. As a result, it is possible to sequentially generate explanatory sentences frame images of which it is determined to generate the explanatory sentences among the sequentially acquired frame images. Such a configuration is effective for analysis that requires a real-time property, such as monitoring using a moving image.

(2) A Case where Image Acquisition Unit 101A Acquires a Plurality of Frame Images from a Moving Image

Based on an analysis result obtained by analyzing each of the plurality of frame images acquired by the image acquisition unit 101A, the selection unit 102A selects a frame image of which the generative model is caused to generate an explanatory sentence from among the plurality of frame images. Even in a case where such a configuration is employed, it is possible to reduce the possibility that a frame image including important information will be omitted from an explanatory sentence generation target of the generative model.

The explanatory sentence generation unit 105A causes the generative model to generate an explanatory sentence of a frame image. As described in the first exemplary embodiment, the “generative model” only needs to be generated through machine learning in such a way that an explanatory sentence of an image can be generated. The explanatory sentence generation unit 105A may generate an explanatory sentence by using an analysis result obtained by analyzing the frame image in the analysis unit 104A in addition to the frame image. In this case, a generative model generated through machine learning in such a way that the generative model can generate an explanatory sentence of an image according to an analysis result with the image and the analysis result as inputs may be used. As a result, it is possible to generate an explanatory sentence in consideration of not only the frame image but also the analysis result. For example, in a case where an analysis result indicating that a suspicious person has been detected is obtained, it is also possible to generate an explanatory sentence focusing on the person.

Specifically, the explanatory sentence generation unit 105A inputs the frame image selected by the selection unit 102A to the generative model together with a prompt for giving an instruction to generate an explanatory sentence of the input image. As a result, the explanatory sentence of the frame image is output from the generative model. The explanatory sentence generation unit 105A may input the analysis result from the analysis unit 104A and the frame image to the generative model together with a prompt for giving an instruction to generate an explanatory sentence in consideration of the analysis result. As a result, the explanatory sentence of the frame image in consideration of the analysis result is output from the generative model.

Here, the prompt generated by the explanatory sentence generation unit 105A may be generated by inputting an analysis result from the analysis unit 104A to a fixed template, for example. The explanatory sentence generation unit 105A may input the analysis result from the analysis unit 104A to a language model and output a prompt for input to the generative model (that is, a prompt for giving an instruction to generate an explanatory sentence of an image in consideration of the analysis result).

As the language model, for example, a model obtained through machine learning of the arrangement of constituents (words and the like) in a sentence or the arrangement of a sentence and a sentence in a writing may be applied. From the viewpoint of obtaining highly accurate output, it is particularly preferable to use an LLM generated through machine learning using a large language corpus. For example, a generative pre-trained transformer (GPT) that outputs a sentence including an input character string by predicting a character string having a high probability following the input character string may be used as an LLM used for extracting assertion details. For example, a text-to-text transfer transformer (T5), bidirectional encoder representations from transformers (BERT), a robustly optimized BERT approach (RoBERTa), efficiently learning an encoder that classifies token replacements accurately (ELECTRA), or the like may be used as an LLM used for extracting the assertion details.

Here, the process or the like of detecting a predetermined target from a frame image in the analysis unit 104A can be completed in a shorter time than the process of causing the generative model to generate an explanatory sentence. Therefore, by generating the explanatory sentence after analyzing and selecting the frame image, it is possible to quickly obtain an analysis result from the frame image, select the frame image, and quickly complete the generation of the explanatory sentence.

The integration unit 106A generates an explanatory sentence of the moving image by using the explanatory sentence generated for each of the plurality of frame images by the generative model. As a result, it is possible to automatically generate an explanatory sentence having appropriate details of the moving image. Here, the “moving image” may be the entire moving image or a part of the moving image included in the content acquired by the acquisition unit 103A. That is, the integration unit 106A can also generate an explanatory sentence of a section by using an explanatory sentence generated for each of a plurality of frame images extracted from a part of the section (which may also be referred to as one scene) of the moving image included in the content acquired by the acquisition unit 103A.

The assertion extraction unit 107A extracts assertion details of the content acquired by the acquisition unit 103A. More specifically, the assertion extraction unit 107A extracts the assertion details of the moving image from the explanatory sentence generated for each frame image by the explanatory sentence generation unit 105A and integrated by the integration unit 106A. In a case where an element (for example, text, speech, or a still image) other than the moving image is included in the content acquired by the acquisition unit 103A, the assertion extraction unit 107A preferably extracts assertion details from the element. The speech may be converted into text by the above-described speech recognition engine, and then the assertion details may be extracted. An explanatory sentence of the still image may be generated by the explanatory sentence generation unit 105A.

For example, the assertion extraction unit 107A may extract assertion details by using a language model such as an LLM. In this case, the assertion extraction unit 107A may input text from which the assertion details are to be extracted to the LLM together with a prompt to output the assertion details of the text. As a result, text indicating the assertion details of the text is output from the LLM. As described above, the text from which the assertion details are to be extracted is the explanatory sentence integrated by the integration unit 106A, or the text acquired or generated from another element included in the content. Here, depending on text to be input, it is also assumed that there are a plurality of assertion details, and thus the assertion extraction unit 107A may generate a prompt that allows the plurality of assertion details to be output.

The assertion extraction unit 107A may access an LLM service provided on a cloud via a communication network and use the LLM service, or may use an LLM processing unit built in the information processing apparatus 1. The assertion extraction unit 107A extracts an output result from the LLM as assertion details.

The verification information acquisition unit 108A acquires verification information serving as a basis for authenticity determination of the content acquired by the acquisition unit 103A. The verification information may be any information that can be used for authenticity determination. A data format of the verification information is not particularly limited. Multimodal data including data in a plurality of data formats may be used as the verification information.

For example, the verification information acquisition unit 108A may search a website based on the text indicating the assertion details extracted by the assertion extraction unit 107A, and acquire text data, image data, speech data, and moving image data included in the website included in the search result as multimodal verification information. The verification information acquisition unit 108A may search for an image, speech, and a moving image on the Internet based on the text indicating the assertion details extracted by the assertion extraction unit 107A, and acquire image data, audio data, and moving image data as search results. A search target may be any target. For example, the verification information acquisition unit 108A may search a predetermined database, data lake, or the like.

The verification information acquisition unit 108A may instruct the LLM to generate a word or a search formula to be used for search based on the text indicating the assertion details extracted by the assertion extraction unit 107A. The verification information acquisition unit 108A may perform the above search by using the word or the search formula generated by LLM.

The verification information acquisition unit 108A may perform multimodal search on a website based on an element other than the moving image included in the content acquired by the acquisition unit 103A, and acquire text data, image data, speech data, and moving image data included in the website included in the search result as multimodal verification information. The verification information acquisition unit 108A may search for an image, sound, and a moving image on the Internet similar to each piece of modal data via the acquisition unit 103A based on the image, the speech, and the moving image included in the content acquired by the acquisition unit 103A, and acquire image data, audio data, and moving image data as search results.

The verification information acquisition unit 108A may acquire the verification information from search results from the top to a predetermined rank in the external information search.

For example, the verification information acquisition unit 108A may acquire the verification information input by a user of the information processing apparatus 1A via the communication unit 12A or the input unit 13A. The verification information acquisition unit 108A may acquire, as the verification information, internal information such as data stored in advance in the storage unit 11A of the information processing apparatus 1A or data stored in a private network in which the information processing apparatus 1A is present.

In a case where the internal information is used as the verification information, the verification information acquisition unit 108A does not need to perform search. The verification information acquisition unit 108A may search internal information to be used as the verification information. As a search method, a method similar to the case of using external information as the verification information can be applied.

The verification information acquisition unit 108A may perform both the search for the external information described above and the acquisition of the internal information described above. That is, the verification information acquisition unit 108A may use both the information acquired through the search and the information acquired without the search as the verification information.

The moving image and the still image included in the multimodal verification information acquired by the verification information acquisition unit 108A as described above are converted into text by the explanatory sentence generation unit 105A. The speech included in the verification information is converted into text by the speech recognition engine. Here, in a case where the text obtained through text conversion is too long or redundant, a process such as inputting the text to an LLM to summarize the text may be performed. In a case where there are a plurality of text elements included in the verification information acquired by the verification information acquisition unit 108A as described above, the text elements may be combined to form one text.

The authenticity determination unit 109A determines the authenticity of the assertion details of the content acquired by the acquisition unit 103A based on the explanatory sentence that the explanatory sentence generation unit 105A causes the generative model to generate. For example, the authenticity determination unit 109A may perform the authenticity determination by using a language model such as an LLM. In this case, the authenticity determination unit 109A may input the text (text indicating the assertion details of the content) extracted by the assertion extraction unit 107A and the verification information (non-text element is converted into text) acquired by the verification information acquisition unit 108A to the LLM together with a prompt for giving an instruction to determine the authenticity of the assertion details based on the verification information and output a determination result. As a result, text indicating the authenticity determination result is output from the LLM. The authenticity determination result may be indicated by a binary value of “true” or “false”, or may be indicated by evaluation results of a plurality of levels such as “true”, “slightly true”, “slightly false”, and “false”. As the authenticity determination result, the degree of likelihood of “true” may be indicated by a numerical value (0 to 100 or the like). An LLM constructed in the information processing apparatus 1A may be used, or an LLM outside the information processing apparatus 1A may be used, which is common in each example using the LLM. One LLM may be used for a plurality of different applications, or an LLM optimized for an application may be used for each application.

The presentation control unit 110A presents various types of information to the user of the information processing apparatus 1A. Methods and aspects of presentation are optional. For example, the presentation control unit 110A may cause an output device connected to the information processing apparatus 1A to output information via the output unit 14A, or may cause an information processing terminal used by the user via a communication network to output information via the communication unit 12A. An output aspect may be display output, speech output, or print output. For example, the presentation control unit 110A may display an image indicating the determination result from the authenticity determination unit 109A on a display device to present the determination result to the user.

As described above, the information processing apparatus 1A includes the image acquisition unit 101A that acquires a frame image that is a constituent of a moving image that is an analysis target using a generative model subjected to machine learning in such a way that the generative model can generate an explanatory sentence of an image, and the selection unit 102A that selects a frame image as a target of which an explanatory sentence is to be generated by the generative model based on an analysis result obtained by analyzing the acquired frame image. Therefore, it is possible to achieve an effect that it is possible to reduce the possibility that a frame image including important information among frame images extracted from a moving image will be omitted from an explanatory sentence generation target of the generative model.

As described above, the explanatory sentence generation unit 105A may cause the generative model to generate an explanatory sentence of the frame image by using the frame image and an analysis result for the frame image. As a result, in addition to the effects achieved by the information processing apparatus 1, it is possible to achieve an effect that an explanatory sentence can be generated in consideration of not only the frame image but also the analysis result.

As described above, the analysis unit 104A may perform analysis according to an analysis method of detecting a predetermined target from a frame image. In this case, the selection unit 102A selects a frame image based on the detection result from the analysis unit 104A. Since the process of detecting a predetermined target from a frame image can be completed in a shorter time than the process of causing the generative model to generate an explanatory sentence, it is possible to obtain an analysis result quickly, select a frame image, and quickly complete the generation of the explanatory sentence.

As described above, the image acquisition unit 101A may sequentially acquire time-series frame images from a moving image. In this case, the selection unit 102A performs a process of determining whether to cause the explanatory sentence generation unit 105A (generative model) to generate an explanatory sentence of a frame image every time the frame image is acquired based on an analysis result obtained by analyzing the frame image acquired by the image acquisition unit 101A. As a result, it is possible to sequentially generate explanatory sentences frame images of which it is determined to generate the explanatory sentences among the sequentially acquired frame images.

As described above, the image acquisition unit 101A may acquire a plurality of frame images from a moving image. In this case, the selection unit 102A selects a frame image of which an explanatory sentence is to be generated by the explanatory sentence generation unit 105A (generative model) from among the plurality of frame images based on an analysis result obtained by analyzing each of the plurality of frame images acquired by the image acquisition unit 101A. Even in a case where such a configuration is employed, it is possible to reduce the possibility that a frame image including important information will be omitted from an explanatory sentence generation target of the generative model.

As described above, the integration unit 106A generates an explanatory sentence of the moving image by using the explanatory sentence generated for each of the plurality of frame images by the generative model. Therefore, according to the information processing apparatus 1A, in addition to the effects achieved by the information processing apparatus 1, it is possible to achieve an effect that an explanatory sentence having appropriate details of the moving image can be automatically generated.

### (Example of Selection)

FIG. 4 is a diagram illustrating an example of selection of a frame image extracted from a moving image. In the example of FIG. 4, the image acquisition unit 101A acquires a plurality of frame images such as frame images A11, A12, and A13 from a moving image A1.

FIG. 4 illustrates an example in which it is determined whether to generate explanatory sentences of frame images A11 and A12 among the plurality of frame images. Specifically, the analysis unit 104A analyzes the frame image A11 by using analysis engines A to C to generate an analysis result. The selection unit 102A determines whether to generate an explanatory sentence of the frame image A11 based on the analysis result. In the example in FIG. 4, it is determined to generate an explanatory sentence of the frame image A11. Therefore, the explanatory sentence generation unit 105A inputs the frame image A11 to a generative model M1 to generate an explanatory sentence.

The analysis unit 104A also analyzes the frame image A12 by using the analysis engines A to C to generate an analysis result, similarly to the frame image A11. The selection unit 102A determines whether to generate an explanatory sentence of the frame image A12 based on the analysis result. In the example in FIG. 4, it is determined that an explanatory sentence of the frame image A12 is not to be generated. Thus, an explanatory sentence of the frame image A12 is not generated.

### (Example of Selection Based on Analysis Result)

A selection method based on the analysis result may be determined in advance according to an analysis method or the like to be applied. For example, in a case where the analysis unit 104A performs analysis using a video analysis engine, the selection unit 102A may select a frame image from which a predetermined object and/or event has been detected by the video analysis engine as a target of which an explanatory sentence is to be generated by the generative model. For example, in a case where the analysis unit 104A performs analysis for detecting the occurrence of abnormality, the selection unit 102A may select a frame image from which the analysis unit 104A has detected the occurrence of abnormality as a target of which an explanatory sentence is to be generated by the generative model.

The selection unit 102A may select a frame image of which an explanatory sentence is to be generated by the generative model based on each of analysis results for time-series frame images. For example, in a case where an analysis result for a certain frame image from the analysis unit 104A is different from an analysis result for a frame immediately before the frame image, the selection unit 102A may select the frame image as a target of which an explanatory sentence is to be generated by the generative model. As a specific example, the selection unit 102A may select a frame image from which a new object has been detected or a frame image from which a new event has been detected as a target of which an explanatory sentence is to be generated by the generative model. In a case where an object detected in the previous frame image is not detected in the next frame image, the selection unit 102A may select the next frame image as a target of which an explanatory sentence is to be generated by the generative model. Similarly, in a case where an event detected in the previous frame image is not detected in the next frame image, the selection unit 102A may select the next frame image as a target of which an explanatory sentence is to be generated by the generative model. For example, the selection unit 102A may select a frame image in which a position of the detected object greatly changes as a target of which an explanatory sentence is to be generated by the generative model.

In a case where the analysis unit 104A performs analysis using a detection model or the like generated through machine learning in such a way that the detection model or the like detects a predetermined target, it is possible to acquire a numerical value indicating the reliability of a detection result from the model. The selection unit 102A may select a frame image of which an explanatory sentence is to be generated by the generative model by using such a numerical value indicating the reliability of an analysis result. For example, the selection unit 102A may select a frame image of which the reliability of the analysis result is equal to or more than a threshold. Since the reliability of the analysis result is generally low for a frame image or the like in which a subject is shown to be blurred, by performing selection based on the reliability of the analysis result, the frame image or the like in which the subject is shown to be blurred can be excluded from a target of which an explanatory sentence is to be generated by the generative model.

The analysis unit 104A may perform, on the time-series frame images, analysis for calculating a difference between the frame images (a difference between corresponding pixel values) or analysis for calculating an optical flow, that is, analysis for evaluating a magnitude of a change between the frame images. In this case, the selection unit 102A may select a frame image based on the evaluation result.

The analysis unit 104A may analyze one frame image by applying a plurality of analysis methods. In that case, the selection unit 102A may combine the analysis results to select a frame image. For example, in a case where analysis is performed by a plurality of analysis engines as in the example in FIG. 4, a weight indicating the degree of considering the analysis result for selection may be set for each analysis engine. In a case where a frame image is selected in consideration of the reliability together with the analysis result from the analysis engine, a weight for the analysis result and a weight for the reliability may be set. By using such a weight, it is possible to calculate an evaluation value obtained by comprehensively evaluating each analysis result. A frame image can be selected by using the evaluation value.

For example, it is assumed that an analysis result from the analysis engine A illustrated in FIG. 4 indicates that a predetermined object has been detected, and the reliability of the analysis result is equal to or more than a threshold. It is assumed that an analysis result from the analysis engine B indicates that a predetermined event has been detected, and the reliability of the analysis result is less than the threshold. It is assumed that an analysis result from the analysis engine C indicates that a detection target has not been detected.

It is assumed that the weights of the analysis engines A to C are set to 0.1, 0.5, and 0.7, respectively, the weight for the detection of a predetermined object or event is set to 1.0, and the weight for the reliability of the analysis result being equal to or more than the threshold is set to 0.3. In this case, the evaluation value for the analysis result from the analysis engine A is calculated as {0.1×(1.0+0.3)}=0.13. The evaluation value for the analysis result from the analysis engine B is calculated as (0.5×1.0)=0.5. The evaluation value for the analysis result from the analysis engine C is 0. Therefore, the evaluation value obtained by combining the analysis results from the analysis engines A to C is calculated as (0.13+0.5+0)=0.63. The selection unit 102A may select a frame image based on the evaluation value. For example, the selection unit 102A may select a frame image having an evaluation value equal to or more than a threshold, or may select a predetermined number of frame images having greater evaluation values among a plurality of frame images. A weighted sum of the evaluation values for the plurality of analysis results may be selected as a comprehensive evaluation result in the same manner as in a case where another analysis method such as optical flow is applied. Instead of using the weighted sum of the evaluation values as the comprehensive evaluation result, a sum of evaluation values (a value calculated without setting a weight) or a statistical value such as an average value, a minimum value, or a maximum value of the evaluation values may be used as the comprehensive evaluation result.

The information processing apparatus 1A may include a plurality of analysis units 104A that analyze frame images. In this case, the selection unit 102A selects the frame image based on an analysis result obtained by each of the plurality of analysis units 104A analyzing the frame image acquired by the image acquisition unit 101A. As a result, in addition to the effects achieved by the information processing apparatus 1, it is possible to achieve an effect that the accuracy of selection can be enhanced in consideration of a plurality of analysis results. The plurality of analysis units 104A may be those to which different analysis methods are applied (for example, analysis is performed by different analysis engines), or analysis units having a common analysis method may be included among the plurality of analysis units 104A. This is because even in a case where analysis methods are common, analysis results may be different in a case where trained models used for analysis are different, or the like.

### (Flow of a Process)

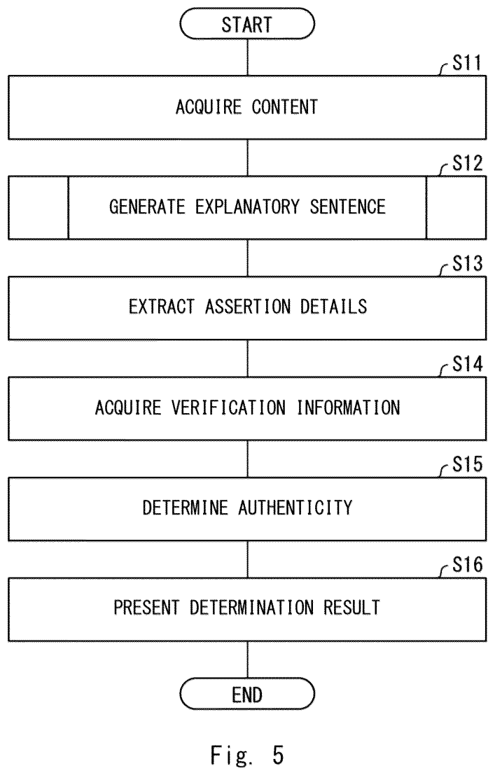

A flow of a process executed by the information processing apparatus 1A will be described with reference to FIG. 5. FIG. 5 is a flowchart illustrating an example of a process executed by the information processing apparatus 1A.

In S11, the acquisition unit 103A acquires content that is an authenticity determination target. Any content acquisition method may be used. For example, the acquisition unit 103A may acquire a content that is input via the communication unit 12A or the input unit 13A. For example, the acquisition unit 103A may automatically acquire a content from a predetermined acquisition destination.

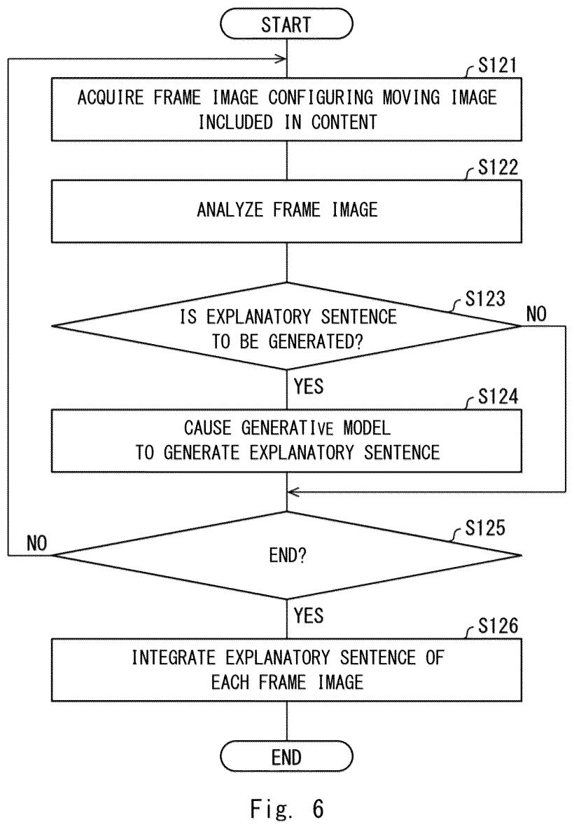

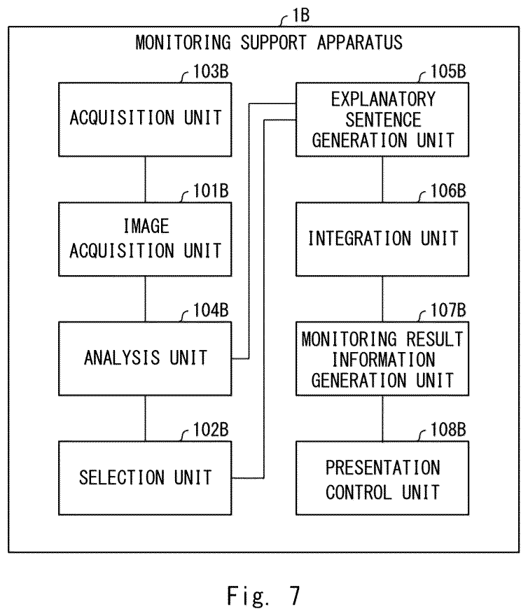

In S12, an explanatory sentence of a moving image included in the content acquired in S11 is generated. Details of S12 will be described later with reference to FIG. 6.

In S13, the assertion extraction unit 107A extracts assertion details of the content acquired in S11. Specifically, the assertion extraction unit 107A extracts the assertion details from the explanatory sentence of the moving image included in the content generated in S12. In a case where an element other than the moving image is included in the content, the assertion extraction unit 107A extracts the assertion details in consideration of such an element.

In S14, the verification information acquisition unit 108A acquires verification information serving as a basis for authenticity determination of the assertion details of the content acquired in S11. As described above, either or both of the external information and the internal information may be acquired as the verification information. In a case where the acquired verification information includes a non-text element, text obtained through conversion of the non-text element may be used as the verification information.

In S15, the authenticity determination unit 109A determines the authenticity of the content acquired in S11 based on the verification information acquired in S14. Specifically, the authenticity determination unit 109A inputs the text indicating the assertion details extracted in S13 and the verification information (non-text element is converted into text) acquired in S14 to an LLM, and outputs an authenticity determination result from the LLM.

In S16, the presentation control unit 110A presents the authenticity determination result (determination result) generated by the authenticity determination unit 109A in S16 to a user. The presentation control unit 110A may present a report including basis information indicating the basis of the determination result in addition to the determination result for the authenticity of the assertion details. For example, such a report may be generated by the LLM by inputting, in addition to the determination result from the authenticity determination unit 109A, the explanation of a verification target and information indicating the verification process to the LLM.

### (Flow of Generation of Explanatory Sentence)

Next, a flow of an explanatory sentence generation process in S12 will be described with reference to FIG. 6. FIG. 6 is a flowchart illustrating a flow of an explanatory sentence generation process. FIG. 6 includes processes of the selection method according to the present exemplary embodiment.

In S121, the image acquisition unit 101A acquires one frame image configuring the moving image from the moving image included in the content acquired in S11 in FIG. 5.

In S122, the analysis unit 104A analyzes the frame image acquired in S121. For example, the analysis unit 104A may analyze the frame image acquired in S121 by using the person detection engine and attempt to detect a person shown in the frame image.

In S123, the selection unit 102A determines whether the frame image acquired in S121 is selected as a target of which an explanatory sentence is to be generated by the generative model based on the analysis result in S122. In a case where YES is determined in S123, the process proceeds to S124. In a case where NO is determined in S123, the process skips S124 and proceeds to S125.

In S124, the explanatory sentence generation unit 105A inputs the frame image acquired in S121 to the generative model, and causes the generative model to generate an explanatory sentence of the frame image.

In S125, the image acquisition unit 101A determines whether to end extraction of a frame image. A condition for ending the extraction of a frame image may be determined in advance. For example, the image acquisition unit 101A may determine to end the extraction of frame images on condition that the extraction of the last frame image in the chronological order among the frame images configuring the moving image included in the content acquired in S11 in FIG. 5 has ended. For example, the image acquisition unit 101A may determine to end the extraction of frame images on condition that the extraction of the last frame image in chronological order among the frame images configuring one scene of one moving image has ended.

In a case where YES is determined in S125, the process proceeds to S126. On the other hand, in a case where NO is determined in S125, the process returns to S121. In S121 following S125, the image acquisition unit 101A acquires a frame image subsequent to the previously acquired frame image.

In step S126, the integration unit 106A integrates the respective explanatory sentences of the plurality of frame images generated by repeatedly performing steps S121 to S124 to generate an explanatory sentence of the moving image. As a result, the process in FIG. 6 is ended, and subsequently, the processes in and after S13 in FIG. 5 are performed. It is not essential to integrate the explanatory sentences. In a case where the explanatory sentences are not integrated, the authenticity determination may be performed by using the individual explanatory sentences or the assertion details extracted from the explanatory sentences.

FIG. 6 illustrates an example in which the process of sequentially acquiring the time-series frame images from the moving image and determining whether to cause the generative model to generate explanatory sentences of the acquired frame images is performed every time the frame images are acquired. However, an explanatory sentence generation process is not limited to this example.

For example, as described above, a plurality of frame images may be acquired from the moving image, and a frame image of which an explanatory sentence is to be generated by the generative model may be selected from among the plurality of frame images. In this case, the image acquisition unit 101A acquires a plurality of time-series frame images in S121, and the analysis unit 104A analyzes these frame images in S122. In step S123, the selection unit 102A selects a frame image of which an explanatory sentence is to be generated by the generative model from among the plurality of frame images acquired in step S121. In this case, the selection unit 102A may select a predetermined number of frame images having higher evaluation results among the plurality of frame images. Alternatively, for each frame image, the selection unit 102A may determine whether an evaluation result for the frame image satisfies a predetermined condition, and select a frame image determined to satisfy the predetermined condition. In S124, the explanatory sentence generation unit 105A generates an explanatory sentence of one or a plurality of frame images selected in S123. Thereafter, S125 is skipped, and the process proceeds to S126.

### (Verification Apparatus)

Since the information processing apparatus 1A has a function of determining the authenticity of assertion details of a content, the information processing apparatus 1A can also be referred to as a verification apparatus. That is, as described above, the verification apparatus described in the second exemplary embodiment includes the selection unit 102A that selects a frame image as a target of which an explanatory sentence is to be generated by a generative model subjected to machine learning in such a way that the generative model can generate an explanatory sentence of an image based on an analysis result obtained by analyzing a frame image that is a constituent of a moving image included in a content that is an authenticity determination target, and the authenticity determination unit 109A that determines authenticity of assertion details of the content based on the explanatory sentence generated by the generative model. According to this verification apparatus, it is possible to reduce the possibility that a frame image including important information will be omitted from an explanatory sentence generation target of the generative model, and thus, it is possible to improve the accuracy and reliability of an explanatory sentence. By generating a highly accurate and highly reliable explanatory sentence, it is possible to achieve an effect that the accuracy and reliability of authenticity determination can be improved.

The function of the verification apparatus described above can also be achieved by a program. A verification program according to the present exemplary embodiment causes a computer to function as selection means for selecting a frame image as a target of which an explanatory sentence is to be generated by a generative model subjected to machine learning in such a way that the generative model can generate an explanatory sentence of an image based on an analysis result obtained by analyzing a frame image that is a constituent of a moving image included in a content that is an authenticity determination target, and authenticity determination means for determining authenticity of assertion details of the content based on the explanatory sentence generated by the generative model. According to this verification program, it is possible to reduce the possibility that a frame image including important information will be omitted from an explanatory sentence generation target of the generative model, and thus, it is possible to improve the accuracy and reliability of an explanatory sentence. By generating a highly accurate and highly reliable explanatory sentence, it is possible to achieve an effect that the accuracy and reliability of authenticity determination can be improved.

A verification method according to the present exemplary embodiment includes: a selection process in which at least one processor selects a frame image as a target of which an explanatory sentence is to be generated by a generative model subjected to machine learning in such a way that the generative model can generate an explanatory sentence of an image based on an analysis result obtained by analyzing a frame image that is a constituent of a moving image included in a content that is an authenticity determination target, and an authenticity determination process in which the processor determines authenticity of assertion details of the content based on the explanatory sentence generated by the generative model. According to this verification method, it is possible to reduce the possibility that a frame image including important information will be omitted from an explanatory sentence generation target of the generative model, and thus, it is possible to improve the accuracy and reliability of an explanatory sentence. By generating a highly accurate and highly reliable explanatory sentence, it is possible to achieve an effect that the accuracy and reliability of authenticity determination can be improved.

### Third Exemplary Embodiment

A third exemplary embodiment will be described in detail with reference to the drawings. Constituents having the same functions as the constituents described in the above-described exemplary embodiment are denoted by the same reference signs, and the description thereof will be appropriately omitted. An application scope of each technique adopted in the present exemplary embodiment is not limited to the present exemplary embodiment. That is, each technique adopted in the present exemplary embodiment can also be adopted in the other exemplary embodiments included in the present disclosure within the scope in which no particular technical problem occurs. Each technique illustrated in each of the drawings referred to for describing the present exemplary embodiment can be employed in the other exemplary embodiments included in the present disclosure within the scope in which no particular technical problem occurs.

### (Configuration of Monitoring Support Apparatus 1B)

A configuration of a monitoring support apparatus 1B according to the present exemplary embodiment will be described with reference to FIG. 7. FIG. 7 is a block diagram illustrating a configuration of the monitoring support apparatus 1B. The monitoring support apparatus 1B includes an acquisition unit 103B, an image acquisition unit 101B, an analysis unit 104B, a selection unit 102B, an explanatory sentence generation unit 105B, an integration unit 106B, a monitoring result information generation unit 107B, and a presentation control unit 108B.

The acquisition unit 103B acquires a moving image generated by imaging a monitoring target. Any monitoring target may be set. For example, the monitoring target may be a person, an article, or a place. Any moving image acquisition method may be used. For example, the acquisition unit 103B may acquire a moving image input by a user of the monitoring support apparatus 1B, or may acquire a moving image captured by a predetermined monitoring camera or the like from the monitoring camera or the like.

Similarly to the image acquisition unit 101 described in the first exemplary embodiment, the image acquisition unit 101B acquires a frame image that is a constituent of a moving image that is an analysis target using a generative model subjected to machine learning in such a way that the generative model can generate an explanatory sentence of an image. As described above, since the acquisition unit 103B acquires the moving image generated by imaging the monitoring target, the moving image is an analysis target. Therefore, the image acquisition unit 101B acquires (may also be referred to as “extracts”) a frame image that is a constituent of the moving image from the moving image that is an analysis target.

The analysis unit 104B analyzes the frame image acquired by the image acquisition unit 101B, similarly to the analysis unit 104A described in the first exemplary embodiment. Similarly to the analysis method applied by the analysis unit 104A, any analysis method applied by the analysis unit 104B may also be used.

Similarly to the selection unit 102 described in the first exemplary embodiment, the selection unit 102B selects a frame image as a target of which an explanatory sentence is to be generated by the generative model based on an analysis result obtained by analyzing the frame image acquired by the image acquisition unit 101B. As described above, the acquisition unit 103B acquires a moving image generated by imaging a monitoring target, and the image acquisition unit 101B acquires a frame image from the moving image. Therefore, the selection unit 102B selects a frame image as a target of which the generative model is caused to generate an explanatory sentence based on an analysis result obtained by analyzing a frame image that is a constituent of a moving image generated by imaging a monitoring target.

Similarly to the explanatory sentence generation unit 105A described in the second exemplary embodiment, the explanatory sentence generation unit 105B causes the generative model to generate an explanatory sentence of the frame image selected by the selection unit 102B.

Similarly to the integration unit 106A described in the second exemplary embodiment, the integration unit 106B generates an explanatory sentence of a moving image by using an explanatory sentence generated for each of a plurality of frame images by the generative model.

The monitoring result information generation unit 107B generates monitoring result information indicating the monitoring result for the monitoring target by using the explanatory sentence generated by the generative model under the control of the explanatory sentence generation unit 105B. For example, the monitoring result information generation unit 107B may use a word extracted from the explanatory sentence as the monitoring result information. For example, the monitoring result information generation unit 107B may input the explanatory sentence to a language model such as an LLM to generate monitoring result information for explaining a monitoring result. The explanatory sentence generated by the generative model may be used as the monitoring result information without any change, and in this case, the monitoring result information generation unit 107B is omitted.

The presentation control unit 108B presents various types of information to a user of the information processing apparatus 1A, similarly to the presentation control unit 110A described in the second exemplary embodiment. For example, the presentation control unit 108B presents the monitoring result information generated by the monitoring result information generation unit 107B to the user. Any aspect of presenting the monitoring result information may be used. For example, the presentation control unit 108B may cause a speech output device such as a speaker to output the monitoring result information by speech, or may cause the monitoring result information to be superimposed and displayed on the moving image that is a basis for the monitoring result information.

As described above, the monitoring support apparatus 1B employs a configuration including the selection unit 102B that selects a frame image as a target of which an explanatory sentence is to be generated by a generative model subjected to machine learning in such a way that the generative model can generate an explanatory sentence of an image based on an analysis result obtained by analyzing a frame image that is a constituent of a moving image generated by imaging a monitoring target, and the presentation control unit 108B that presents, to a user, monitoring result information indicating a monitoring result for the monitoring target, generated by using the explanatory sentence generated by the generative model. Thus, according to the monitoring support apparatus 1B, it is possible to reduce the possibility that a frame image including important information among frame images extracted from a moving image generated by imaging a monitoring target will be omitted from an explanatory sentence generation target of the generative model. Therefore, according to the monitoring support apparatus 1B, it is possible to achieve an effect of enabling efficient monitoring with a reduced possibility of occurrence of overlooking of an important event.

The function of the monitoring support apparatus 1B described above can also be achieved by a program. A monitoring support program according to the present exemplary embodiment causes a computer to function as selection means for selecting a frame image as a target of which an explanatory sentence is to be generated by a generative model subjected to machine learning in such a way that the generative model can generate an explanatory sentence of an image based on an analysis result obtained by analyzing a frame image that is a constituent of a moving image generated by imaging a monitoring target, and presentation control means for presenting, to a user, monitoring result information indicating a monitoring result for the monitoring target, generated by using the explanatory sentence generated by the generative model. According to this monitoring support program, it is possible to reduce the possibility that a frame image including important information among frame images extracted from a moving image generated by imaging a monitoring target will be omitted from an explanatory sentence generation target of the generative model. Therefore, according to this monitoring support program, it is possible to achieve an effect of enabling efficient monitoring with a reduced possibility of occurrence of overlooking of an important event.

### (Monitoring Support Method)

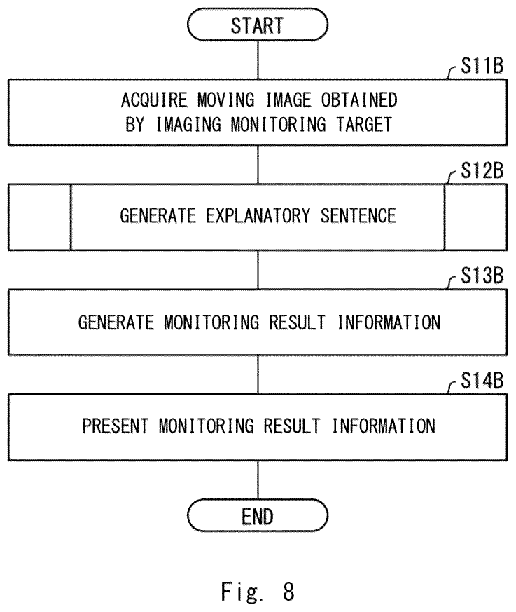

A flow of a process executed by the monitoring support apparatus 1B will be described with reference to FIG. 8. FIG. 8 is a flowchart illustrating an example of a process executed by the monitoring support apparatus 1B.

In S11B, the acquisition unit 103B acquires a moving image generated by imaging a monitoring target.

In S12B, an explanatory sentence of the moving image acquired in S11B is generated. S12B includes a selection process of the monitoring support method according to the present exemplary embodiment. Specifically, in S12B, a process similar to that in FIG. 6 described above is performed, and a process of extracting and selecting a frame image from the moving image acquired in S11B, generation of an explanatory sentence of the selected frame image, and integration of the generated explanatory sentences are performed.

In S13B, the monitoring result information generation unit 107B generates monitoring result information indicating a monitoring result for the monitoring target by using the explanatory sentence generated in S12B.

In S14B (presentation control process), the presentation control unit 108B presents the monitoring result information generated in S13B to the user. Accordingly, the process in FIG. 8 is ended. The monitoring result information may be generated and presented by acquiring a moving image with a predetermined length every predetermined period. In this case, after the process in S14B is ended, the process returns to S11B to acquire the next moving image.

As described above, the monitoring support method according to the present exemplary embodiment employs a method including a selection process in which at least one processor selects a frame image as a target of which an explanatory sentence is to be generated by a generative model subjected to machine learning in such a way that the generative model can generate an explanatory sentence of an image based on an analysis result obtained by analyzing a frame image that is a constituent of a moving image generated by imaging a monitoring target, and a presentation control process in which the processor presents, to a user, monitoring result information indicating a monitoring result for the monitoring target, generated by using the explanatory sentence generated by the generative model. Therefore, according to the monitoring support method according to the present example embodiment, it is possible to reduce the possibility that a frame image including important information among frame images extracted from a moving image generated by imaging a monitoring target will be omitted from an explanatory sentence generation target of the generative model. Therefore, according to this selection method, it is possible to achieve an effect of enabling efficient monitoring with a reduced possibility of occurrence of overlooking of an important event.

### Modified Examples

Each process described in the above-described exemplary embodiments may be executed by any subject, and an executing entity is not limited to the above-described example. For example, a system having functions similar to those of the information processing apparatuses 1 and 1A and the monitoring support apparatus 1B can be constructed by a plurality of apparatuses capable of communicating with each other. An executing entity of each process illustrated in the flowcharts of FIGS. 5, 6, and 8 may be one apparatus (also referred to as a processor) or a plurality of apparatuses (also referred to as processors).

### Implementation Examples Using Software

Some or all of the functions of the information processing apparatuses 1 and 1A and the monitoring support apparatus 1B may be achieved by hardware such as an integrated circuit (IC chip) or may be achieved by software.

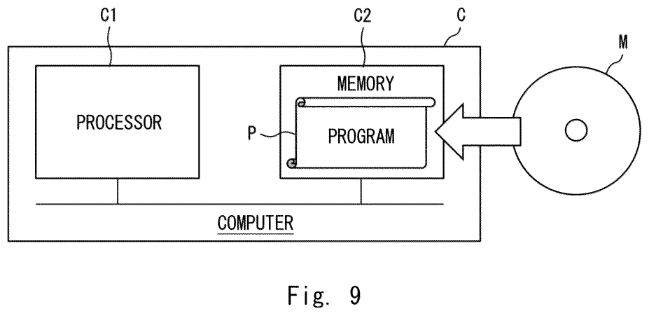

In the latter case, the information processing apparatuses 1 and 1A and the monitoring support apparatus 1B are implemented by, for example, a computer that executes a command of a program that is software for achieving each function. An example of such a computer (hereinafter, referred to as a computer C) is illustrated in FIG. 9. FIG. 9 is a block diagram illustrating a hardware configuration of the computer C that functions as the information processing apparatus 1 or 1A, or the monitoring support apparatus 1B.

The computer C includes at least one processor C1 and at least one memory C2. In the memory C2, a program P for causing the computer C to operate as the information processing apparatus 1 or 1A, or the monitoring support apparatus 1B is recorded. In the computer C, the processor C1 reads the program P from the memory C2 and executes the program P, thereby achieving the functions of the information processing apparatus 1 or 1A, or the monitoring support apparatus 1B.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof may be used. As the memory C2, for example, a flash memory, a hard disk drive (HDD), a solid state drive (SSD), or a combination thereof may be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P may be recorded in a non-transitory tangible recording medium M readable by the computer C. As such a recording medium M, for example, a tape, a disk, a card, a semiconductor memory, a programmable logic circuit, or the like may be used. The computer C can acquire the program P via such a recording medium M. The program P may be transmitted via a transmission medium. As such a transmission medium, for example, a communication network, a broadcast wave, or the like may be used. The computer C can also acquire the program P via such a transmission medium.

The above-described functions of the information processing apparatuses 1 and 1A and the monitoring support apparatus 1B may be achieved by a single processor provided in a single computer, may be achieved by a plurality of processors provided in a single computer in cooperation, or may be achieved by a plurality of processors respectively provided in a plurality of computers in cooperation. The program for causing the information processing apparatus 1 or 1A, or the monitoring support apparatus 1B to achieve each of the above-described functions may be stored in a single memory provided in a single computer, may be stored in a distributed manner in a plurality of memories provided in a single computer, or may be stored in a distributed manner in a plurality of memories respectively provided in a plurality of computers.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### Supplementary Note

The present disclosure includes the technologies described in the following supplementary notes. However, the present disclosure is not limited to the technologies described in the following supplementary note, and various modifications can be made within the scope described in the claims.

### Supplementary Note A1

An information processing apparatus including:
at least one memory storing instructions; and
at least one processor executing the instructions to:
acquire a frame image that is a constituent of a moving image that is an analysis target using a generative model subjected to machine learning in such a way that the generative model is able to generate an explanatory sentence of an image,
analyze the acquired frame image, and
select a frame image as a target of which an explanatory sentence is to be generated by the generative model based on an analysis result.

### Supplementary Note A2

The information processing apparatus according to Supplementary Note A1, in which the at least one processor causes the generative model to generate an explanatory sentence of the frame image by using the frame image and an analysis result for the frame image.

### Supplementary Note A3

The information processing apparatus according to Supplementary Note A1 or A2, in which the at least one processor selects the frame image based on a plurality of analysis results for the acquired frame image.

### Supplementary Note A4

The information processing apparatus according to any one of Supplementary Notes A1 to A3, in which the at least one processor detects a predetermined target from the frame image, and selects the frame image based on a detection result for the predetermined target.

### Supplementary Note A5

The information processing apparatus according to any one of Supplementary Notes A1 to A4, in which the at least one processor sequentially acquires time-series frame images from the moving image, and performs a process of determining whether to cause the generative model to generate explanatory sentences of the frame images every time the frame images are acquired based on an analysis result obtained by analyzing the acquired frame images.

### Supplementary Note A6

The information processing apparatus according to any one of Supplementary Notes A1 to A4, in which the at least one processor acquires a plurality of frame images from the moving image, and selects a frame image of which an explanatory sentence is to be generated by the generative model from among the plurality of frame images based on an analysis result obtained by analyzing each of the plurality of acquired frame images.

### Supplementary Note A7

The information processing apparatus according to any one of Supplementary Notes A1 to A6, in which the at least one processor generates an explanatory sentence of the moving image by using an explanatory sentence generated for each of the plurality of frame images by the generative model.

### Supplementary Note A8

A verification apparatus including:
selection means for selecting a frame image as a target of which an explanatory sentence is to be generated by a generative model subjected to machine learning in such a way that the generative model can generate an explanatory sentence of an image based on an analysis result obtained by analyzing a frame image that is a constituent of a moving image included in a content that is an authenticity determination target; and
authenticity determination means for determining authenticity of assertion details of the content based on the explanatory sentence generated by the generative model.

### Supplementary Note A9

A monitoring support apparatus including:
selection means for selecting a frame image as a target of which an explanatory sentence is to be generated by a generative model subjected to machine learning in such a way that the generative model is able to generate an explanatory sentence of an image based on an analysis result obtained by analyzing a frame image that is a constituent of a moving image generated by imaging a monitoring target; and
presentation control means for presenting, to a user, monitoring result information indicating a monitoring result for the monitoring target, generated by using the explanatory sentence generated by the generative model.

### Supplementary Note B1

A selection method including:
an image acquisition process of acquiring, by a computer, a frame image that is a constituent of a moving image that is an analysis target using a generative model subjected to machine learning in such a way that the generative model is able to generate an explanatory sentence of an image; and
a selection process of selecting, by the computer, a frame image as a target of which an explanatory sentence is to be generated by the generative model based on an analysis result obtained by analyzing the acquired frame image.

### Supplementary Note B2

A verification method including:
a selection process of selecting, by a computer, a frame image as a target of which an explanatory sentence is to be generated by a generative model subjected to machine learning in such a way that the generative model can generate an explanatory sentence of an image based on an analysis result obtained by analyzing a frame image that is a constituent of a moving image included in a content that is an authenticity determination target; and
an authenticity determination process of determining, by the computer, authenticity of assertion details of the content based on the explanatory sentence generated by the generative model.

### Supplementary Note B3

A monitoring support method including:
a selection process of selecting, by a computer, a frame image as a target of which an explanatory sentence is to be generated by a generative model subjected to machine learning in such a way that the generative model is able to generate an explanatory sentence of an image based on an analysis result obtained by analyzing a frame image that is a constituent of a moving image generated by imaging a monitoring target; and
a presentation control process of presenting, by the computer, to a user, monitoring result information indicating a monitoring result for the monitoring target, generated by using the explanatory sentence generated by the generative model.

### Supplementary Note C1

A non-transitory computer-readable recording medium storing a selection program for causing a computer to execute:
an image acquisition process of acquiring a frame image that is a constituent of a moving image that is an analysis target using a generative model subjected to machine learning in such a way that the generative model is able to generate an explanatory sentence of an image; and
a selection process of selecting a frame image as a target of which an explanatory sentence is to be generated by the generative model based on an analysis result obtained by analyzing the acquired frame image.

### Supplementary Note C2

A non-transitory computer-readable recording medium storing a verification program for causing a computer to execute:
a selection process of selecting a frame image as a target of which an explanatory sentence is to be generated by a generative model subjected to machine learning in such a way that the generative model can generate an explanatory sentence of an image based on an analysis result obtained by analyzing a frame image that is a constituent of a moving image included in a content that is an authenticity determination target; and
an authenticity determination process of determining authenticity of assertion details of the content based on the explanatory sentence generated by the generative model.

### Supplementary Note C3

A non-transitory computer-readable recording medium storing a monitoring support program for causing a computer to execute:
a selection process of selecting a frame image as a target of which an explanatory sentence is to be generated by a generative model subjected to machine learning in such a way that the generative model is able to generate an explanatory sentence of an image based on an analysis result obtained by analyzing a frame image that is a constituent of a moving image generated by imaging a monitoring target; and
a presentation control process of presenting, to a user, monitoring result information indicating a monitoring result for the monitoring target, generated by using the explanatory sentence generated by the generative model.

Some or all of the elements described in Supplementary Notes A2 to A7 dependent on Supplementary Note A1 can also be dependent on Supplementary Notes B1 and C1 based on the same dependency relationship as Supplementary Notes A2 to A7. Some or all of the elements described in any supplementary note may be applied to various types of hardware, software, recording means for recording software, systems, and methods.

What is claimed is:

1. An information processing apparatus comprising:
at least one memory storing instructions; and
at least one processor executing the instructions to:
acquire a frame image that is a constituent of a moving image that is an analysis target using a generative model subjected to machine learning in such a way that the generative model is able to generate an explanatory sentence of an image,
analyze the acquired frame image, and
select a frame image as a target of which an explanatory sentence is to be generated by the generative model based on an analysis result.

2. The information processing apparatus according to claim 1, wherein the at least one processor causes the generative model to generate an explanatory sentence of the frame image by using the frame image and an analysis result for the frame image.

3. The information processing apparatus according to claim 1, wherein the at least one processor selects the frame image based on a plurality of analysis results for the acquired frame image.

4. The information processing apparatus according to claim 1, wherein the at least one processor detects a predetermined target from the frame image, and selects the frame image based on a detection result for the predetermined target.

5. The information processing apparatus according to claim 1, wherein the at least one processor sequentially acquires time-series frame images from the moving image, and performs a process of determining whether to cause the generative model to generate explanatory sentences of the frame images every time the frame images are acquired based on an analysis result obtained by analyzing the acquired frame images.

6. The information processing apparatus according to claim 1, wherein the at least one processor acquires a plurality of frame images from the moving image, and selects a frame image of which an explanatory sentence is to be generated by the generative model from among the plurality of frame images based on an analysis result obtained by analyzing each of the plurality of acquired frame images.

7. The information processing apparatus according to claim 1, wherein the at least one processor generates an explanatory sentence of the moving image by using an explanatory sentence generated for each of the plurality of frame images by the generative model.

8. A selection method comprising:
an image acquisition process of acquiring, by a computer, a frame image that is a constituent of a moving image that is an analysis target using a generative model subjected to machine learning in such a way that the generative model is able to generate an explanatory sentence of an image; and
a selection process of selecting, by the computer, a frame image as a target of which an explanatory sentence is to be generated by the generative model based on an analysis result obtained by analyzing the acquired frame image.

9. The selection method according to claim 8, wherein the computer causes the generative model to generate an explanatory sentence of the frame image by using the frame image and an analysis result for the frame image.

10. The selection method according to claim 8, wherein the computer selects the frame image based on a plurality of analysis results for the acquired frame image.

11. The selection method according to claim 8, wherein the computer detects a predetermined target from the frame image, and selects the frame image based on a detection result for the predetermined target.

12. The selection method according to claim 8, wherein the computer sequentially acquires time-series frame images from the moving image, and performs a process of determining whether to cause the generative model to generate explanatory sentences of the frame images every time the frame images are acquired based on an analysis result obtained by analyzing the acquired frame images.

13. The selection method according to claim 8, wherein the computer acquires a plurality of frame images from the moving image, and selects a frame image of which an explanatory sentence is to be generated by the generative model from among the plurality of frame images based on an analysis result obtained by analyzing each of the plurality of acquired frame images.

14. The selection method according to claim 8, wherein the computer generates an explanatory sentence of the moving image by using an explanatory sentence generated for each of the plurality of frame images by the generative model.

15. A non-transitory computer-readable recording medium storing a selection program for causing a computer to execute:
an image acquisition process of acquiring a frame image that is a constituent of a moving image that is an analysis target using a generative model subjected to machine learning in such a way that the generative model is able to generate an explanatory sentence of an image; and
a selection process of selecting a frame image as a target of which an explanatory sentence is to be generated by the generative model based on an analysis result obtained by analyzing the acquired frame image.

16. The non-transitory computer-readable recording medium according to claim 15, wherein the selection program causes the computer to cause the generative model to generate an explanatory sentence of the frame image by using the frame image and an analysis result for the frame image.

17. The non-transitory computer-readable recording medium according to claim 15, wherein the selection program causes the computer to select the frame image based on a plurality of analysis results for the acquired frame image.
